(19) United States
(12) Patent Application Publication
(10) Pub. No.: US 2012/0030664 A1
(43) Pub. Date: Feb. 2, 2012

(54) PROCESSING OF SOFTWARE OBJECTS MOVED INTO A DROPZONE REGION OF AN APPLICATION

(75) Inventors: Hilmar Demant, Karlsdorf (DE); Sebastian Droll, Heidelberg (DE); Joachim Fitzer, Schriesheim (DE); Ioannis Grammatikakis, Maxdorf (DE); Jan Heiler, Walldorf (DE); Juergen Sattler, Wiesloch (DE); Frank Schertel, Mannheim (DE); Markus Viol, Walldorf (DE); Thorsten Weber, Mannheim (DE)

(73) Assignee: SAP AG, Walldorf (DE)

(21) Appl. No.: 12/847,247

(22) Filed: Jul. 30, 2010

(51) Int. Cl. G06F 9/44; G06F 17/30; G06F 15/16

(52) U.S. Cl. 717/171

(57) ABSTRACT

A non-transitory computer-readable storage medium storing code representing instructions that when executed are configured to cause a processor to perform a process. The code can comprise code to receive, on a client side of a network, an indicator that a first software object has been moved from a first application into a dropzone region of a second application. The code can include code to receive an indicator that a second software object has been moved into the dropzone region of the second application, and code to access a plurality of dropzone conditions. The code can include code to determine that a dropzone condition from the plurality of dropzone conditions has been satisfied based on the first software object and the second software object both being moved into the dropzone region, and code to send to a server side of a network an indicator that the dropzone condition has been satisfied.

### TECHNICAL FIELD

This description relates to processing of software objects moved within or between applications.

### BACKGROUND

Many known software applications support moving a software object from one location to another location using, for example, a user interface device such as a mouse. Often the movement is performed by clicking on the software object and dragging it to a different location. The movement can be between locations within two different applications, or different locations within a single application. This type of functionality can be referred to as drag-and-drop functionality. As a feature, drag-and-drop can be a fast and easy-to-learn technique that users can use to perform tasks such as moving objects from one location to another location, but known drag-and-drop functionality is limited in various ways. Thus, a need exists for systems, methods, and apparatus to address the shortfalls of present technology and to provide other new and innovative features.

### SUMMARY

According to one general aspect, a non-transitory computer-readable storage medium storing code representing instructions that when executed are configured to cause a processor to perform a process. The code can comprise code to receive, on a client side of a network, an indicator that a first software object has been moved from a first application into a dropzone region of a second application. The code may also include code to receive an indicator that a second software object has been moved into the dropzone region of the second application, and may also include code to access a plurality of dropzone conditions. The code may also include code to determine that a dropzone condition from the plurality of dropzone conditions has been satisfied based on the first software object and the second software object both being moved into the dropzone region, and may also include code to send to a server side of a network an indicator that the dropzone condition has been satisfied.

According to another general aspect, a computer system can include instructions stored on a non-transitory computer-readable storage medium. The computer system can include an object analyzer on a server side of a network configured to receive a first software object and a second software object from a client device on a client side of the network. The object analyzer can be configured to analyze the first software object and the second software object, and the object analyzer can be configured to send a content value representing at least a portion of content of the first software object to the client device. The computer system may also include an action engine configured to receive, from the client device and after the content value is sent by the object analyzer, an instruction to execute an action related to at least one of the first software object or the second software object. The instruction can be defined in response to a dropzone condition being satisfied when the first software object and the second software object are moved into a dropzone region at the client device.

According to yet another general aspect, a method including executing instructions recorded on a non-transitory computer-readable storage media using at least one processor. The method can include receiving, using the at least one processor, an indicator that a first software object has been moved into a dropzone region of an application, and receiving, using the at least one processor, an indicator that a second software object has been moved into the dropzone region of the application. The method can also include identifying the first software object as a first object type and the second software object as a second object type different from the first object type, and determining that a dropzone condition has been satisfied based on the first software object being the first object type and the second software object being the second object type. Finally, the method can also include sending, in response to the dropzone condition being satisfied, the first software object, the second software object, and an instruction configured to trigger execution of an action associated with at least one of the first software object or the second software object.

The details of one or more implementations are set forth in the accompanying drawings and the description below. Other features will be apparent from the description and drawings, and from the claims.

### BRIEF DESCRIPTION OF THE DRAWINGS

FIG. 1 is a block diagram of an application manager configured to handle processing associated with a dropzone region within an application.

FIG. 2 is a flowchart that illustrates a method for handling processing associated with a dropzone region of an application.

FIG. 3 illustrates an example of data that can be stored in a dropzone database.

FIG. 4 is a timing diagram that illustrates processing of software objects moved into a dropzone region on a client side of a network.

FIG. 5 is a flowchart that illustrates a method for determining whether or not a dropzone condition associated with a dropzone region has been satisifed.

FIG. 6 is another timing diagram that illustrates processing of software objects moved into a dropzone region on a client side of a network.

FIG. 7 is yet another timing diagram that illustrates processing of software objects moved into a dropzone region on a client side of a network.

FIG. 8 is timing diagram that illustrates processing of software objects moved into a dropzone region on a client side of a network based on prompts.

### DETAILED DESCRIPTION

An application manager on a client side of a network is configured to determine whether or not one or more dropzone conditions associated with a dropzone region of an application have been satisfied when one or more software objects (e.g., virtual objects, application objects) have been moved (e.g., moved using a drag-and-drop function) into the dropzone region from another application(s), or from within the same application. In some embodiments, the dropzone condition(s) can be satisfied based on one or more metadata values (e.g., content values, object type values) that represent information that can be used to characterize the software object(s). The applications can be, for example, web-based applications, business applications, stand-alone executable applications, and/or so forth. In some embodiments, the application manager can be associated with a client device on the client side of the network. In some embodiments, the application manager can be configured to send an indicator to a server device server side of a network so that one or more actions can be performed in response to the dropzone condition(s) being satisfied. In some embodiments, the software object(s) associated with the satisfied dropzone condition can be buffered by the application manager and/or the server device so that the action(s) that are performed by the application manager and/or server device can be performed on or using the software object(s). In some embodiments, the server device can be configured to analyze the software object(s) to facilitate the client device in determining whether or not a dropzone condition has been satisfied.

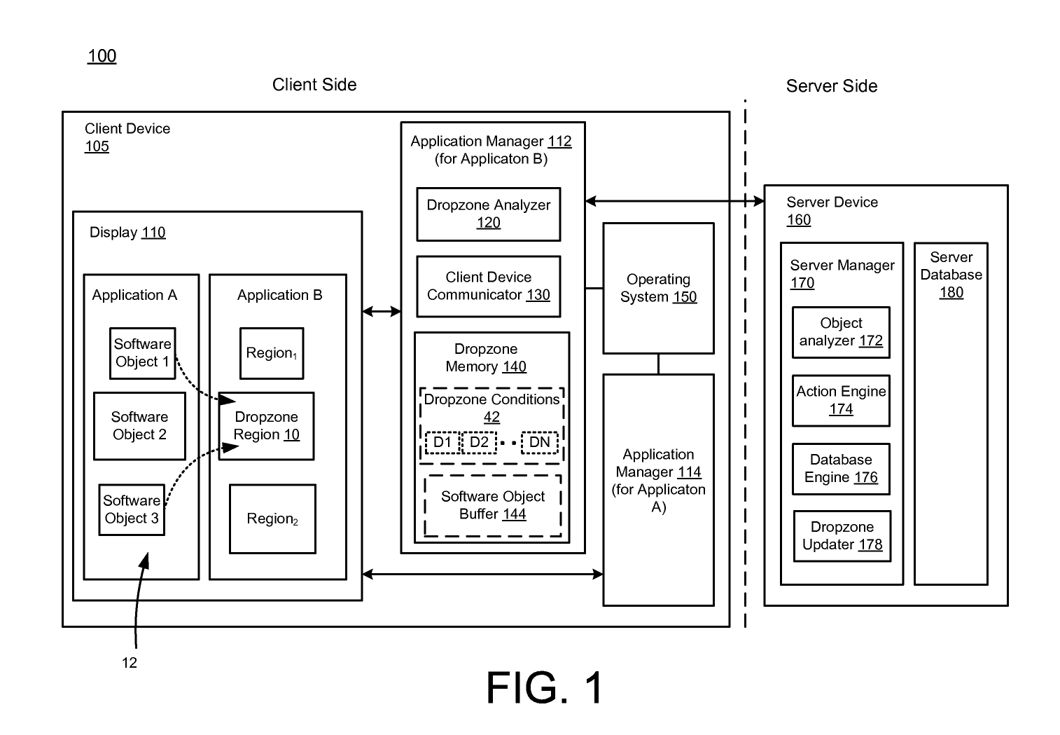

FIG. 1 is a block diagram of an application manager 112 of a client device 105 configured to handle processing associated with a dropzone region 10 within an application. Specifically, the application manager 112 is configured to handle processing associated with the dropzone region 10 included in application B. Application B also includes Region₁ and Region₂, which are not dropzone regions within application B. As shown in FIG. 1, an application manager 114 is an application manager associated with application A, and the application manager 112 is an application manager associated with application B.

The application manager 112 includes a dropzone analyzer 120, a client device communicator 130, and a dropzone memory 140. The dropzone memory 140 is configured to store dropzone conditions 42, which include dropzone conditions D1 through DN, and has a portion of its memory allocated as a software object buffer 144. The software object buffer 144 is configured to store one or more of the software objects 12 in response to the software object(s) being moved into the dropzone region 10 of application B.

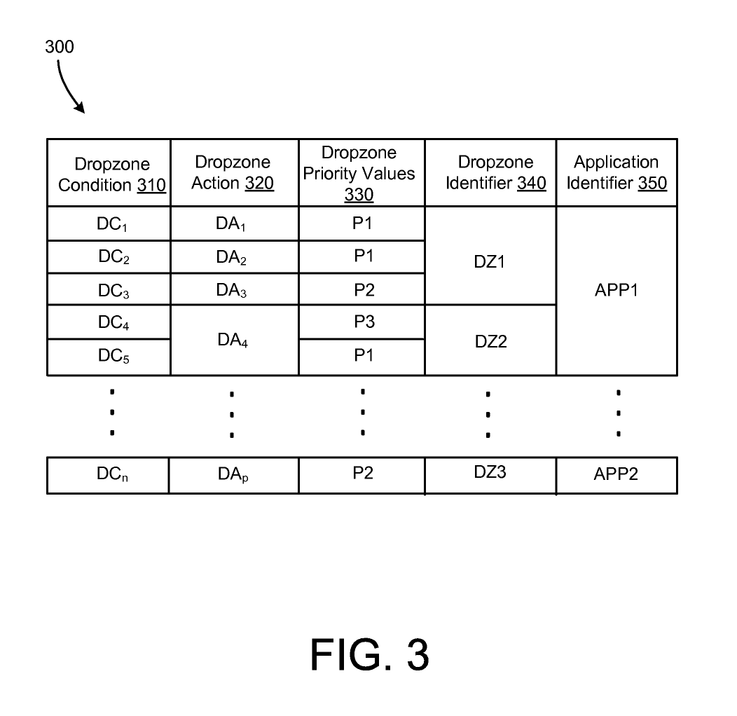

The application manager 112 is configured to determine whether or not one or more of the dropzone conditions 42 has been satisfied when one or more of the software objects 12 are moved into the dropzone region 10 of application B. In the embodiment shown in FIG. 3, the dropzone analyzer 120 is configured to determine that dropzone condition D2 from the dropzone conditions 42 is satisfied when software object 1 and software object 3 have been moved from application A into the dropzone region 10 of application B. In the embodiment shown in FIG. 1, software object 2 is not moved from application A into the dropzone region 10 of application B. Although the embodiment shown in FIG. 1 is related to the movement of software objects 12 between two different applications, the description contained herein can be applied to movement of software objects within a single application, movement of software objects from several different applications to a single application, or movement of software objects from one or more applications to several dropzone regions within several different applications.

The dropzone analyzer 120 is configured to send an indicator to the server device 160 when the dropzone condition D2 has been satisfied. The server device 160 includes an action engine 174 configured to perform an action in response to the dropzone condition D2 being satisfied.

In some embodiments, the software objects 12 can be, for example, a software file such as a document, an image file, a video file, an audio file, and/or so forth associated with an application such as application A. One or more of the software objects 12 can be, or can include, any type of executable software module such as a computer program based on, but not limited to, micro-code or micro-instructions, machine instructions, such as produced by a compiler, code used to produce a web service, and files containing higher-level instructions that are executed by a computer using an interpreter. For example, one or more of the software objects 12 may be implemented using Java, C++, or other programming languages (e.g., object-oriented programming languages) and development tools. In some embodiments, one or more of the software objects 12 can be, or can be associated with, a background process with functionality that is not visible on the display 110. In some embodiments, one or more of the software objects 12 can define at least a portion of one or more applications or can be associated with one or more applications.

The dropzone conditions 42 can include various types of dropzone conditions that can be based on one or more metadata values. The dropzone analyzer 120 can be configured to determine whether or not a dropzone condition (from the dropzone conditions 42) has been satisfied based on one or more metadata values. The metadata values can represent any information that can be used to characterize one or more of the software objects. The metadata values can include, for example, content values, object type values, and/or so forth. More details related to various types of metadata values are described below.

The dropzone conditions 42 can be stored in a dropzone database (not shown), and an example of a dropzone database is shown in FIG. 3. Although not shown in FIG. 1, in some embodiments, a dropzone region such as dropzone region 10 may be associated with a default dropzone condition. In some embodiments, the default dropzone condition can be based on the context of the dropzone region and/or the application within which the dropzone region resides (is displayed). For example, the dropzone condition can be related to processing of a particular type of text file because the dropzone region is for that particular type of text file. The dropzone condition can be automatically satisfied when a text file (or set of text files), or a text file (or set of text files) of the particular type, is moved into the dropzone region.

In some embodiments, one or more of the dropzone conditions 42 can be satisfied based on an object type value. For example, one or more of the dropzone conditions 42 can be satisfied when a software object of a particular software object type (which can be represented by an object type value) is moved into the dropzone region 10. In some embodiments, one or more of the dropzone conditions 42 can be satisfied when the software object type is an audio file (e.g., a .wav file), an image file (e.g., a Joint Photographic Experts Group (JPEG) file), a text file (e.g., an American Standard Code for Information Interchange (ASCII) file, a rich text formal (rtf) file), a portable document format (pdf) file, a video file (e.g., a Motion Picture Experts Group (MPEG) file), and so forth. In some embodiments, an object type value can be referred to as a file type or file type value.

In some embodiments, one or more of the dropzone conditions 42 can be satisfied when a software object moved into the dropzone region 10 has a certain type of content (which can be represented by a content value) such as information about a particular application, data related to a particular operation and/or issue, etc. In some embodiments, the dropzone analyzer 120 can be configured to send one or more software objects 12 moved into the dropzone region 10 to an object analyzer 172 of a server device 160 so that information (e.g., content, metadata) associated with of the software object(s) can be analyzed. The analysis of the software object(s) can be returned (e.g., sent) to the dropzone analyzer 120 (as metadata values) so that the dropzone analyzer 120 can determine whether or not one or more of the dropzone conditions 42 have been satisfied.

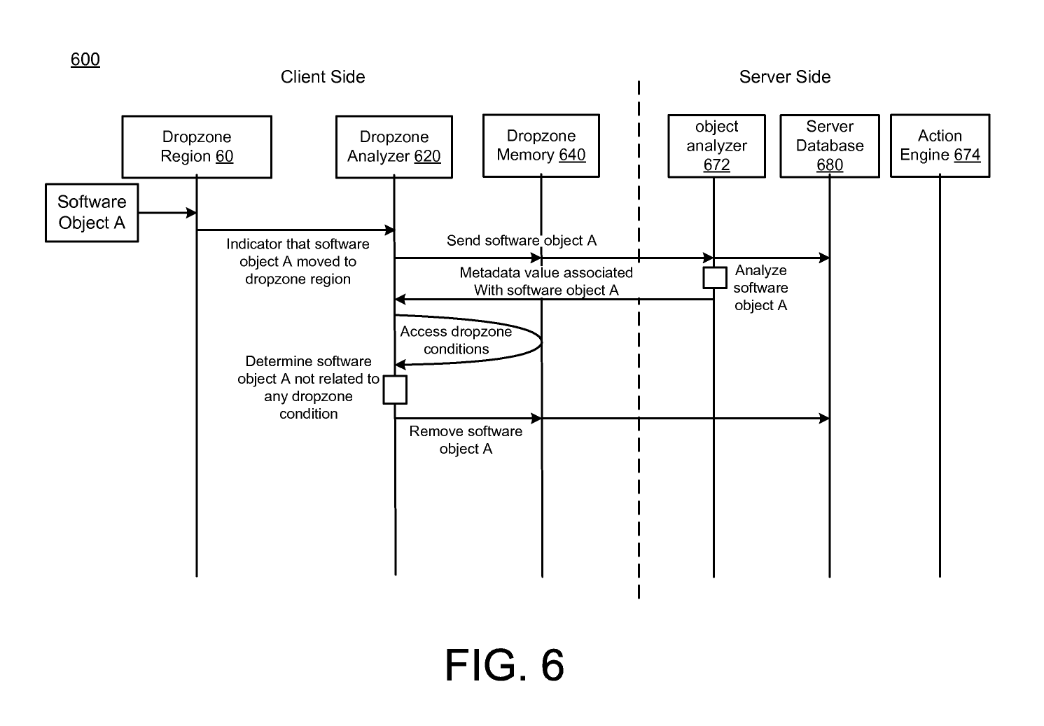

Although not shown, in some embodiments, the application manager 112, or a portion thereof (e.g., the dropzone analyzer 620 of the application manager 112), can include an object analyzer configured to analyze one or more software objects 12 so that the dropzone analyzer 120 can determine whether or not one or more dropzone conditions 42 have been satisfied. More details related to analysis of software object(s) using an object analyzer is discussed in connection with, for example, FIG. 6.

In some embodiments, the dropzone conditions 42 may be satisfied based on other types of metadata values. The metadata values can be related to, or can represent, for example, any information associated with a software object. For example, one or more of the dropzone conditions 42 can be based on metadata values related to, or representing a date/time stamp associated with a software object, a creation time of a software object, a function of a software object, a history (e.g., a usage history, a change history) of a software object, an owner of a software object, a name of a software object, and/or so forth.

In some embodiments, one or more of the dropzone conditions 42 can be satisfied when two or more of the software objects 12 are moved into the dropzone region 10. For example, one or more of the dropzone conditions 42 may be satisfied when more than one software object is moved into the dropzone region 10. For example, the dropzone condition may be satisfied when two of the software objects 12 are moved into the dropzone region 10 regardless of the content of the software objects 12 or type of each of the software objects 12. In some embodiments, one or more of the dropzone conditions 42 can be satisfied when two or more of the software objects 12 are moved into the dropzone region 10 in a particular order. In some embodiments, information about the number of software objects moved into the dropzone region 10, or order of software objects moved into the dropzone region 10, can be represented as a number value, or as an order value, respectively (which can be types of metadata values).

In some embodiments, one or more of the dropzone conditions 42 can be satisfied when one or more software objects 12 are moved into the dropzone region 10 with a particular timing. For example, one or more of the dropzone conditions 42 may be satisfied when a software object (e.g., software object 2) is moved into the dropzone region 10 during a specified period of time, or after a particular application event such as processing a particular type of data or display of an alert/prompt. In some embodiments, one or more of the dropzone conditions 42 may be satisfied when a software object is moved into the dropzone region 10 within (or after) a specified period of time after another subject object has been moved into the dropzone region 10. In some embodiments, the timing can be represented as a timing value (which can be a type of metadata value).

In some embodiments, one or more of the dropzone conditions 42 can be defined with a particular timing so that certain processing actions are not unintentionally performed with respect to one or more of the software objects 12 if, for example, a software object is moved into the dropzone region at a much later time for a different purpose. In other words, a first dropzone condition from the dropzone conditions 42 can be defined to expire (after a specified time period), or closed out (after a specified time period), so that when a user moves one or more software objects 12 into the dropzone region 10 for a different purpose (i.e., to trigger a second dropzone condition from the dropzone conditions 42) at a much later time, the first dropzone condition from the dropzone conditions 42 will not be satisfied.

Although not shown, in some embodiments, an application can include more than one dropzone region. In such embodiments, one or more of the dropzone conditions 42 can be satisfied based on one or more software objects 12 being moved into each of several dropzone regions. In some embodiments, each of the dropzone regions can be associated with different (or the same) dropzone conditions. For example, dropzone region 10 can be associated with a subset of the dropzone conditions 42 and another dropzone region (not shown) can be associated with a different subset of the dropzone conditions 42. In some embodiments, the different dropzone regions can be associated with different functions of the application. For example, a first dropzone region can be used to trigger processing of a particular type of software object and a second dropzone region can be used to process another type of software object.

In some embodiments, one or more of the dropzone conditions 42 can include a combination of the dropzone conditions including those described above. In some embodiments, one or more of the dropzone conditions 42 may be satisfied only when two or more software objects 12 of a particular type and/or two or more software objects 12 having a particular type of content are moved into the dropzone region 10 with a specified timing. For example, the dropzone condition D2 may be satisfied because software object 1 is a first type of software object that is moved into the dropzone region 10 within a specified time period that software object 3, which is a second type of software object, is moved into the dropzone region 10.

The dropzone analyzer 120 can be configured to analyze the dropzone conditions 42 serially or can be configured to analyze several dropzone conditions 42 in parallel. In some embodiments, the dropzone conditions 42 can be categorized and/or indexed so that they can be analyzed in a desirable fashion (e.g., with a desirable efficiency, at a desirable speed).

In some embodiments, multiple dropzone conditions can be satisified in response to one or more software objects 12 being moved into the dropzone region 10. For example, although not shown, dropzone condition D1 and dropzone condition D2 could be satisfied if software object 2 and software object 3 are both moved into the dropzone region 10. In such instances, one of the satisfied dropzone conditions (e.g., dropzone condition D1) can have a priority (represented by a condition priority value) over the other satisfied dropzone condition. More details related to priorities of dropzone conditions are discussed in connection with FIG. 3.

As mentioned above, one or more actions can be performed (or triggered) by the action engine 174 at the server device 160 on the server side of the network 100 in response to one or more of the dropzone conditions 42 being satisfied on the client side of the network 100. In some embodiments, the action can include parsing the software object(s), storing the software object(s), analyzing the software object(s). In some embodiments, a search of the server database 180 by database engine 176 of the server manager 170 can be an action performed by the server device 160 in response to one or more of the dropzone conditions 42 being satisfied. The server device 160 can be configured to trigger execution of an application (or a portion thereof) at the server device 160 and/or at the client device 105 in response to, for example, the dropzone condition D2 being satisfied. In some embodiments, one or more results of an action performed by the server device 160 can be sent to (e.g., returned to) the client device 105 on the client side of the network 100.

In some embodiments, the client device 105 can be configured to send one or more of the software objects 12 related to a satisfied dropzone condition 42 to the server device 160 for processing based on the action at the server device 160. For example, the client device 105 can be configured to send software object 3 to the server device 160 so that an action related to software object 3 can be performed at the server device 160 in response to dropzone condition D2 being satisfied (based on software object 3).

In some embodiments, the action performed by the action engine 174 can include triggering processing (e.g., execution of an action) of one or more of the software objects 12 associated with a satisfied dropzone condition at the client device 105. For example, the server device 160 can be configured to trigger an action related to software object 1 in response to the dropzone conditions D2 being satisfied. Although not shown, in some embodiments, the application manager 112 of the client device 105 can include an action engine with all or some of the functionality of the action engine 174 of the server device 160. In such embodiments, the action engine 174 may optionally not be included in the server device 160.

One or more actions performed at the server device 160 can depend on the dropzone condition (from the dropzone conditions 42) that is satisfied. For example, a particular action can be triggered in response to dropzone condition D2 being satisfied. A separate action can be triggered in response to a different dropzone condition, such as dropzone condition DN being satisfied. More details related to execution of dropzone actions are discussed in connection with the remaining figures.

The client device communicator 130 can be configured to trigger communications related to the dropzone region 10 to a user of the client device 105 (or otherwise interface with the user of the client device 105). For example, the client device communicator 130 can be configured to send a message (e.g., an e-mail message, a chat message) and/or display one or more prompts (e.g., an alert) in the display 110 related to processing associated with the dropzone region 10. For example, client device communicator 130 can be configured to trigger display of one or more alerts that a dropzone condition(s) has not been satisfied when one or more of the dropzone conditions 42 has not been satisfied after one or more software objects 12 have been moved into the dropzone region 10. In some embodiments, the client device communicator 130 can be configured to trigger display of one or more alerts communicating that a software object could not be processed.

In some embodiments, the client device communicator 130 can be configured to prompt a user to move one or more software objects 12 into the dropzone region 10. In some embodiments, the client device communicator 130 can be configured to prompt a user to communicate (e.g., enter) information related to one or more software objects 12 that have been moved into the dropzone region 10. For example, the client device communicator 130 can be configured to prompt a user to identify a particular software object, enter information about the type and/or content of a software object, and/or so forth. In some embodiments, the client device communicator 130 can be configured to receive and/or analyze the response from the user. In some embodiments, the client device communicator 130 can be configured to send the response from the user to the dropzone analyzer 120 so that the dropzone analyzer 120 can use the response to determine whether or not one or more of the dropzone conditions 42 have been satisfied.

In some embodiments, the client device communicator 130 can be configured to present information (e.g., default information, suggested information, initial information) related to one or more software objects 12 in a prompt to a user. In some embodiments, the presented information can be based on an analysis of the one or more software objects 12. The prompt from the client device communicator 130 can be configured so that the user can accept at least a portion of the presented information and/or modify at least a portion of the presented information (via the prompt).

Although not shown, in some embodiments, the server device 160 can include a dropzone analyzer and can be configured to store dropzone conditions. Accordingly, the server device 160 can be configured to determine whether or not one or more dropzone conditions have been satisfied. In such embodiments, the dropzone analyzer 120 can be configured to send information from the client side of the network 100 to the server device 160 on the server side of the network 100 so that the server device 160 can determine whether or not one or more dropzone conditions has been satisfied. In such embodiments, the dropzone analyzer 120 can be configured to access instructions that can be used by the dropzone analyzer 120 to send sufficient information to the dropzone analyzer of the server device 160 to determine whether or not one or more dropzone conditions have been satisfied. The server device 160 can be configured to request (if necessary) and receive information from the application manager 112 so that the server device 160 can determine whether or not a dropzone condition(s) has been satisfied.

In some embodiments, the client device communicator 130 can be configured to present (e.g., select and present) one or more prompts based on one or more prompt condition values. In such embodiments, the prompt(s) may be triggered for display based on one or more of the prompt condition values associated with the prompt(s) being satisfied. In addition, the information included within the prompt(s) can be based on the prompt condition values. In some embodiments, the prompt(s) can each be configured with one or more fields (of a particular user-interface configuration) that can be populated with information to be presented to a user. In some embodiments, the field(s) that are included within the prompt(s) can vary depending on the information to be included within the prompt(s). In such embodiments, the selection of a prompt with a particular configuration may be triggered for display based on a prompt condition value being satisfied.

In some embodiments, one or more analysis results from the object analyzer 172 of the server device 160 can be returned (e.g., sent) to the dropzone analyzer 120 (as metadata values) and presented within one or more prompts. In some embodiments, the analysis result(s) can be mapped into one or more fields of the prompt(s). The prompt can be selected from, for example, a library of prompts based on the analysis result(s) to be included therein.

Although not shown, in some embodiments, the client memory 140 can be implemented as more than one memory component (e.g., more than one random-access memory (RAM) component or disk drive memory) within the client device 105. In some embodiments, the client memory 140 can be, or can include, a non-local memory (e.g., a memory not physically included within the client device 105) on the client side of the network 100. For example, the client memory 140 can be, or can include, a memory shared by multiple client devices (not shown) on the client side of the network 100. In some embodiments, the client memory 140 can be associated with a server device (not shown) on the client side of network and configured to serve several client devices on the client side of the network 100.

In some embodiments, the dropzone conditions 42 stored in the dropzone memory 140 can be a subset of dropzone conditions (not shown) maintained at the server device 160 (and stored at the server database 180). The dropzone conditions maintained at the server device 160 can be referred to as a master set of dropzone conditions. The dropzone conditions 42 stored at the client device 105 can be related to dropzone regions that may be used at the client device 105. Accordingly, the dropzone conditions 42 may not include all of the dropzone conditions that may be maintained at the server device 160.

A dropzone updater 178 of the server device 160 can be configured to send one or more updates related to dropzone conditions 42 (also can be referred to dropzone condition update(s)) to the client device 105 for storage in the dropzone memory 140. The dropzone condition update(s) can include a new dropzone condition, a changed dropzone condition, and/or so forth. The dropzone updater 178 can be configured to send the dropzone condition update(s) in response to a request (in a pull fashion) from the client device 105. The client device 105 can be configured to request updates to one or more of the dropzone conditions 42 on a periodic basis, a random basis, a scheduled basis, and/or so forth.

The dropzone updater 178 can be configured to send one or more updates to the client device 105 without receiving a request from the client device 105. In other words, one or more dropzone condition updates can be pushed to the client device 105 from the server device 160. The server device 160 can be configured to send dropzone conditions update(s) to the client device 105 on a periodic basis, a random basis, a scheduled basis, and/or so forth. In some embodiments, a dropzone condition update can be sent to the client device 105 in response to a change in one or more dropzone conditions maintained at the server device 160 (if, for example, a master set of dropzone conditions are maintained at the server device 160).

In some embodiments, the server device 160 can be configured to push (without a request from the client device 105) a certain set of dropzone conditions to the client device 105 that are frequently used by many similar client devices. The dropzone conditions sent to the client device 105 can be selected based on historical usage data from the client devices. In some embodiments, the server device 160 can be configured to send (e.g., push) (without a request from the client device 105) one or more dropzone condition updates to one or more of the dropzone conditions 42 stored at client device 105 based on information that the client device 105 has used one or more of the dropzone conditions 42 previously.

The application manager 112 and the application manager 114 are configured to operate within an environment that includes an operating system 150. In some embodiments, the operating system 150 can be configured to facilitate transfer of one or more of the software objects 12 from application A to application B. The transfer can be performed using a drag-and-drop function and/or other file transfer system/mechanism, which can be implemented and/or supported by the operating system 150. In some embodiments, the other file transfer system/mechanism can include, for example, transfer of one or more of the software objects 12 using a button (e.g., an add button, an attach button). In some embodiments, transfer of one or more of the software objects 12 can be triggered via a dialog box through which a user can select the one or more software objects 12.

Although not shown in FIG. 1, in some embodiments, one or more software objects 12 may not be moved (e.g., virtually moved) into a dropzone region (and a dropzone region may optionally not be implemented within an application). In such embodiments, one or more of the software objects 12 may instead be selected (e.g., selected via a user-interface) for processing rather than transferred into a dropzone region (if the dropzone exists within an application). In such embodiments, the processing of the software objects 12 at the client device 105 and/or the server device 160 may be triggered by the selection rather than the transferring of the software object(s) 12 into the dropzone region.

The client device 105 can be, for example, a wired device and/or a wireless device (e.g., wi-fi enabled device) and can be, for example, a computing entity (e.g., a personal computing device), a mobile phone, a personal digital assistant (PDA) and/or so forth. The server device 160 can be, for example, a wired device and/or a wireless device (e.g., wi-fi enabled device). The server devices 160 can be, or can include, a server device (e.g., a web server) and/or a host device. The client device 105 and/or the server device 160 can be configured to operate based on one or more platforms (e.g., one or more similar or different platforms) that can include one or more types of hardware, software, firmware, operating systems, runtime libraries, and/or so forth.

In some embodiments, the client device 105 can represent a cluster of devices and/or the server device 160 can represent a cluster of devices (e.g., a server farm). In such an embodiment, the functionality and processing of the client device 105 (e.g., the client component manager 130 of the client device 105) can be distributed to several client devices of the cluster of client devices. Similarly, the functionality and processing of the server device 160 (e.g., the server manager 170 of the server device 160) can be distributed to several devices of the cluster of server devices.

In some embodiments, one or more portions of the components shown in the client device 105 and/or the server device 160 in FIG. 1 can be, or can include, a hardware-based module (e.g., a digital signal processor (DSP), a field programmable gate array (FPGA), a memory), a firmware module, and/or a software-based module (e.g., a module of computer code, a set of computer-readable instructions that can be executed at a computer). For example, in some embodiments, one or more portions of the application manager 112 can be, or can include, a software module configured for execution by at least one processor (not shown). Similarly, one or more portions of the server manager 170 can be a software module configured for execution by at least one processor (not shown). In some embodiments, the functionality of the components can be included in different modules and/or components than those shown in FIG. 1. For example, although not shown, the functionality of the dropzone analyzer 120 can be included in a different module than the dropzone analyzer 120, or divided into several different modules.

Although the network 100 shown in FIG. 1 only includes a single client device 105 and a single server device 160, it should be understood that the devices shown in FIG. 1 are presented only by way of example. In some embodiments, the network 100 can include multiple client devices (such as client device 100) and/or multiple server devices (such as server device 160). Also, although not shown in FIG. 1, the client device 105 and/or server device 160 can be configured to function within various types of network environments. For example, the network 100 can be, or can include, a local area network (LAN), a wide area network (WAN), and/or so forth. The network 100 can be, or can include, a wireless network and/or wireless network implemented using, for example, gateway devices, bridges, switches, and/or so forth. The network 100 can include one or more segments and/or can be have portions based on various protocols such as Internet Protocol (IP) and/or a proprietary protocol. The network 100 can include at least a portion of the Internet.

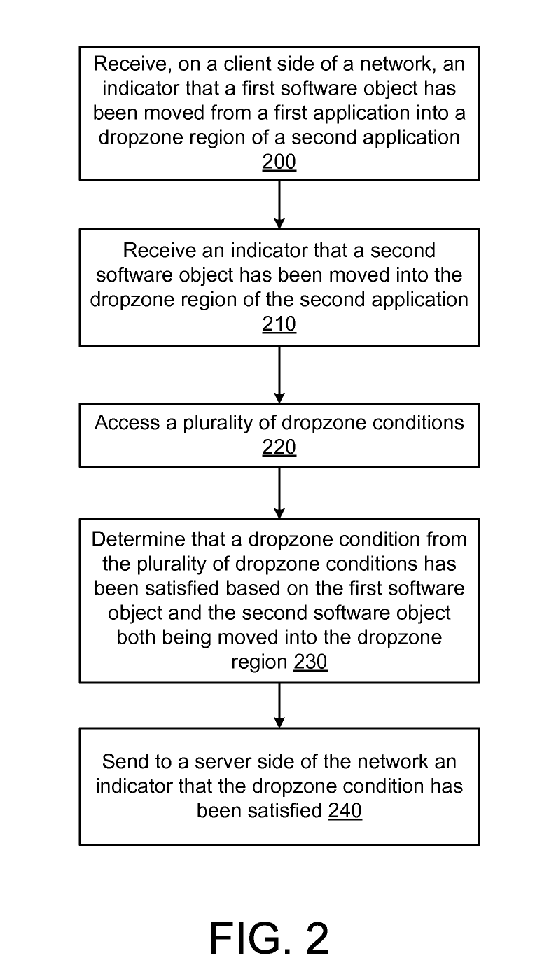

FIG. 2 is a flowchart that illustrates a method for handling processing associated with a dropzone region of an application. As shown in FIG. 2, an indicator that a first software object has been moved from a first application into a dropzone region of a second application is received on a client side of a network (block 200). The first software object can be, for example, a text file, or an image file. The first software object can be moved from the first application into the dropzone region of the second application by a user using, for example, a drag-and-drop function. The first application and the second application can be executing at, for example, a client device on the client side of the network.

An indicator that a second software object has been moved into the dropzone region of the second application is received (block 210). Similar to the first software object, the second software object can be, for example, a text file, or an image file, and the second software object can be moved from the first application into the dropzone region of the second application by a user using, for example, a drag-and-drop function.

A plurality of dropzone conditions are accessed (block 220). The plurality of dropzone conditions can be accessed from a client memory stored on the client side of the network. The dropzone conditions can be a subset of a master set of dropzone conditions maintained at, for example, a server device on a server side of the network.

A dropzone condition from the plurality of dropzone conditions is determined to be satisfied based on the first software object and the second software object both being moved into the dropzone region (block 230). The determination can be made by, for example, a dropzone analyzer of a client device. In some embodiments, the dropzone condition can be satisfied based on the first software object and the second software object both being a particular type of software object and based on the first software object and the second software object both being moved into the dropzone region within a specified period of time.

An indicator that the dropzone condition has been satisfied is sent to a server side of the network (block 240). The indicator can be sent to a server device on the server side of the network in conjunction with the first software object and the second software object. After the indicator has been sent to the server side of the network, an action associated with the first software object and/or the second software object can be performed.

FIG. 3 illustrates an example of data that can be stored in a dropzone database 300. As shown in FIG. 3, the dropzone database 300 includes a dropzone condition 310, a dropzone action 320, a condition priority value 330, a dropzone identifier 340, and an application identifier 350.

The dropzone identifiers 340 can each be an identifier that can be used by a client device and/or a server device to identify or represent a particular dropzone region. For example, a client device can be configured to identify a dropzone region within a particular communication with a server device using at least one of the dropzone identifiers 340. The dropzone identifiers 340 shown in FIG. 3, include dropzone identifiers DZ1 through DZ3. Each of the dropzone identifiers 340 can be a unique identifier such as, for example, a universally unique identifier (UUID), or an identifier that is unique within a particular data space. The dropzone region represented by a particular dropzone identifier can be referred to, in a shorthand fashion, by the dropzone identifier. For example, the dropzone region represented by dropzone identifier DZ1 can be referred to as dropzone region DZ1.

The application identifiers 350 can each be an identifier that can be used by a client device and/or a server device to identify or represent a particular application. For example, a client device can be configured to identify an application using at least one of the application identifiers 350. The application identifiers 350 shown in FIG. 3, include application identifiers APP1 and APP2. Similar to the dropzone identifiers 340, each of the application identifiers 350 can be a unique identifier such as, for example, a UUID, or an identifier that is unique within a particular data space. The application regions represented by a particular application identifier can be referred to, in a shorthand fashion, by the application identifier. For example, the application region represented by application identifier APP1 can be referred to as application region APP1. As shown in FIG. 3, multiple dropzone regions—dropzone region DZ1 and dropzone region DZ2—are associated with application APP1.

The dropzone database 300 shown in FIG. 3 is arranged so that the entries within a row are associated with a dropzone region represented by the dropzone identifier 340 within that row. In other words, the dropzone condition 310, the dropzone action 320, the condition priority value 330, and the application identifier 350 appearing on the same row as a dropzone region represented by a particular dropzone identifier 340 are associated with that dropzone region. For example, the dropzone conditions DC₁ through DC₃ are associated with the dropzone region represented by dropzone identifier DZ1 (which spans several rows).

As shown in FIG. 3, the dropzone actions 320 (dropzone actions DA₁ through DAₚ) are associated with each of the dropzone conditions 310. When the dropzone condition 310 is satisfied, the dropzone action 320 associated with that dropzone condition 310 can be executed. For example, dropzone action DA₃ (shown in column 310) is associated with dropzone condition DC₃ (shown in column 310). When dropzone condition DC₃ is satisfied, the dropzone action DA₃ associated with that dropzone condition DC₃ can be executed.

The condition priority values 330 (P1 through P3) can each be values that represent a priority of a particular dropzone condition 310. The condition priority value P1 has a higher priority than the condition priority value P2, and the condition priority value P2 has a higher priority than the condition priority value P3.

A condition priority value 330 representing a high priority and associated with a dropzone condition 310 can cause that dropzone condition 310 to be processed (e.g., loaded) before another dropzone condition 310 with a condition priority value 330 representing a lower priority. In some embodiments, a dropzone action 320 associated with a dropzone condition 310 that has a relatively high condition priority value may have a processing priority (e.g., an execution priority) over a dropzone action 320 associated with a dropzone condition 310 that has a relatively low condition priority value.

In some embodiments, if multiple dropzone conditions 310 are satisfied, the dropzone condition 310 associated with a higher condition priority value 330 may take priority over the dropzone condition 310 with the lower condition priority value 330. For example, if dropzone condition DC₁ (which is associated with a condition priority value P1) and dropzone condition DCₙ (which is associated with a condition priority value P2) are satisfied, dropzone condition DCₙ, even though it is satisified, may be ignored because it is associated with a lower condition priority value 330 than dropzone condition DC₁.

Although not shown, in some embodiments, dropzone actions, software objects, and/or dropzone regions can also be associated with priority values similar to the condition priority values 330 associated with the dropzone conditions 310. Priority values associated with dropzone regions can be referred to as region priority values, priority values associated with software objects can be referred to as object priority values (e.g., object type priority values, content type priority values), and priority values associated with dropzone actions can be referred to as action priority values.

Conflicts between priority values can be resolved based on, for example, a rules-based algorithm. For example, a conflict between a priority value associated with a dropzone region represented by a dropzone identifier 340 and a priority value of a dropzone action 320 can be resolved using a rules-based algorithm. In some embodiments, precedence of condition priority values can configurable by, for example, a user. In some embodiments, the precendence of condition priority values can be defined based on a rules-based algorithm (which may be configured based on one or more instructions from a user). In some embodiments, condition priority values can be defined (or removed) so that all actions (or a subset of actions) associated with all satisfied dropzone conditions (or a subset of satisfied dropzone conditions) will be performed.

In some embodiments, one or more of the values shown in the dropzone database 300 can be combined into a single value. For example, in some embodiments, the dropzone identifier 340 and the application identifier APP1 can be conflated into a single value. In some embodiments, the data included in the dropzone database 300 can be predefined by, for example, an administrator. In some embodiments, values in addition to those shown in FIG. 3 can be stored in the dropzone database 300. For example, metadata values (e.g., content values, object type values), information about an application manager associated with an application, additional priority values (e.g., object priority values), and/or so forth, can be stored in the dropzone database 300.

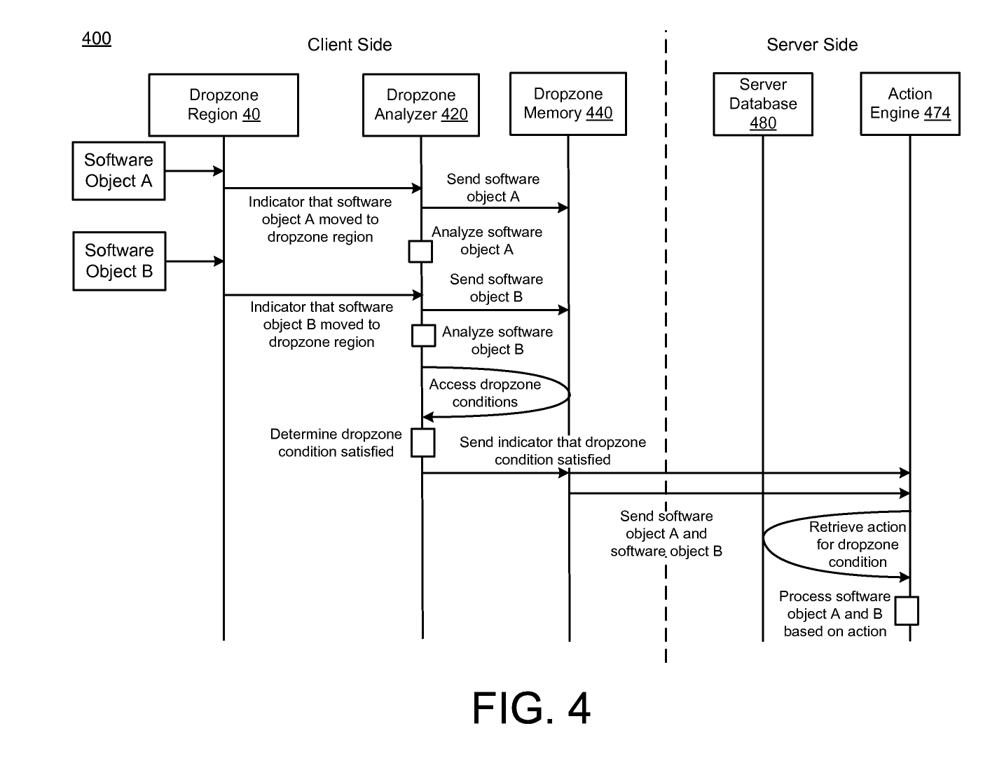

FIG. 4 is a timing diagram that illustrates processing of software objects moved into a dropzone region 40 on a client side of a network 400. As shown in FIG. 4, the dropzone region 40, a dropzone analyzer 420, and a dropzone memory 440 are on the client side of the network 400. A server database 480 and an action engine 474 are disposed on a server side of the network 400.

As shown in FIG. 4, in response to software object A being moved into the dropzone region 40, an indicator that software object A has been moved into the dropzone region 40 is received by the dropzone analyzer 420. The dropzone analyzer 420 is configured to send software object A (e.g., move an instance of software object A) to the dropzone memory 440 (e.g., a dropzone buffer within the dropzone memory 440). In some embodiments, the software object A can be moved from one application into another application (or within a single application) that includes the dropzone region 40 using, for example, a drag-and-drop function.

Software object A is analyzed by the dropzone analyzer 420 after software object A is sent to the dropzone memory 440. The analysis can include, for example, extracting and/or analyzing content from software object A, storing information about software object A, analyzing metadata related to software object A, determining whether software object A is a particular type of software object, and/or so forth.

In response to software object B being moved into the dropzone region 40, an indicator that software object B has been moved into the dropzone region 40 is received by the dropzone analyzer 420. The dropzone analyzer 420 is configured to send software object B (e.g., move an instance of software object B) to the dropzone memory 440 (e.g., a dropzone buffer within the dropzone memory 440). In some embodiments, the software object B can be moved from one application into another application (or within a single application) that includes the dropzone region 40 using, for example, a file transfer application.

Software object B is analyzed by the dropzone analyzer 420 after software object A is sent to the dropzone memory 440. The analysis can include, for example, extracting and/or analyzing content from software object B, storing information about software object B, analyzing metadata related to software object B, determining whether software object B is a particular type of software object, and/or so forth.

As shown in FIG. 4, dropzone conditions are accessed from the dropzone memory 440 by the dropzone analyzer 420 so that the dropzone analyzer 420 can determine whether or not one or more of the dropzone conditions stored in the dropzone memory 440 are satisfied. As shown in FIG. 4, the dropzone analyzer 420 is configured to determine that a dropzone condition has been satisfied. In some embodiments, multiple dropzone conditions may be satisfied in response to software objects A and B being moved into the dropzone region 40.

In some embodiments, the dropzone analyzer 420 can be configured to further analyze the software object A and/or the software object B when determining whether or not one or more of the dropzone conditions have been satisfied. For example, when a first dropzone condition is accessed from the dropzone memory 440 the software object A and/or the software object B can be further analyzed to determine whether or not the first dropzone condition has been satisfied. If the first dropzone condition is not satisfied, a second dropzone condition can be accessed from the dropzone memory 440. When the second dropzone condition is accessed from the dropzone memory 440 the software object A and/or the software object B can be further analyzed to determine whether or not the second dropzone condition has been satisfied. In some embodiments, the dropzone conditions can be analyzed using, for example, a tree-based analysis of dropzone conditions, a hash-based dropzone condition analysis system, a dropzone condition indexing system, a content-addressable memory, and/or a dropzone condition classification method.

In some embodiments, the analysis of the software objects at the dropzone analyzer 420 can be performed before, or in conjunction with (e.g., substantially at the same time as) the sending of the software objects to the dropzone memory 440. For example, software software object B can be analyzed at the dropzone analyzer 420 before the software software object B is sent to the dropzone memory 440.

The dropzone analyzer 420 is configured to send an indicator that the dropzone condition has been satisfied to the action engine 474 on the server side of the network. In some embodiments, the indicator can be included with (or replaced by) an instruction that is sent from the dropzone analyzer 420 to the action engine 474. The dropzone analyzer 420 can be configured to send an identifier of the particular dropzone condition that has been satisfied so that the action engine 474 can determine (e.g., locate, look-up) an action to be performed based on the particular dropzone condition being satisfied. In some embodiments, information such as an identifier of the dropzone region 40 and/or other information can be sent (in addition to, or instead of the identifier of the dropzone condition that has been satisfied) from the dropzone analyzer 420 to the action engine 474 so that the action engine 474 can determine an action to be performed in response to dropzone condition being satisfied.

The dropzone memory 440 is also configured to send software object A (e.g., an instance of software object A) and send software object B (e.g., an instance of software object B) to the action engine 474. The dropzone memory 440 can be triggered to send software objects A and B by the dropzone analyzer 420. In some embodiments, the sending of the indicator (and/or instruction) that the dropzone condition has been satisfied can be performed before, or in conjunction with (e.g., substantially at the same time as) the sending of software objects A and B to the action engine 440.

The action engine 474 is configured to retrieve a dropzone action from the server database 480 based on the indicator (and/or instruction) received from the dropzone analyzer 420 that the dropzone condition has been satisfied. The action to be performed in response to the dropzone condition being satisfied can be determined via a look-up in the server database 480 based on an identifier representing the dropzone condition that has been satisfied. Because the dropzone analyzer 420 has determined which dropzone condition has been satisfied, the action engine 474 does not need to analyze software objects A and B.

The action engine 474 is configured to process software objects A and B based on the action retrieved from the server database 480. Although not shown, in some embodiments, the action engine 474 can be configured to process only software object A or software object B based on the action retrieved from the server database 480. In such embodiments, the dropzone analyzer 420 can be configured to send only the software object to be processed based on an action. The dropzone analyzer 420 can be configured to determine that only one of the software objects may need to be processed by the action engine 474 based on information (e.g., a description of an action, instructions to only send one software object) included in, for example, a dropzone database stored in the dropzone memory 440.

In some embodiments, in response to software object A being moved into the dropzone region 40, the dropzone analyzer 420 is configured to determine that at least one of the dropzone conditions could be satisfied based on a second software object being moved into the dropzone region 40. In such embodiments, the dropzone analyzer 720 can be configured to identify a subset of dropzone conditions that could be satisfied based on a second software object being moved into the dropzone region 40. Accordingly, in response to the indicator that the software object B has been moved into the dropzone region 40, only the subset of dropzone conditions may be analyzed by the dropzone analyzer 420 to determine whether or not a dropzone condition (from the subset of dropzone conditions) has been satisfied.

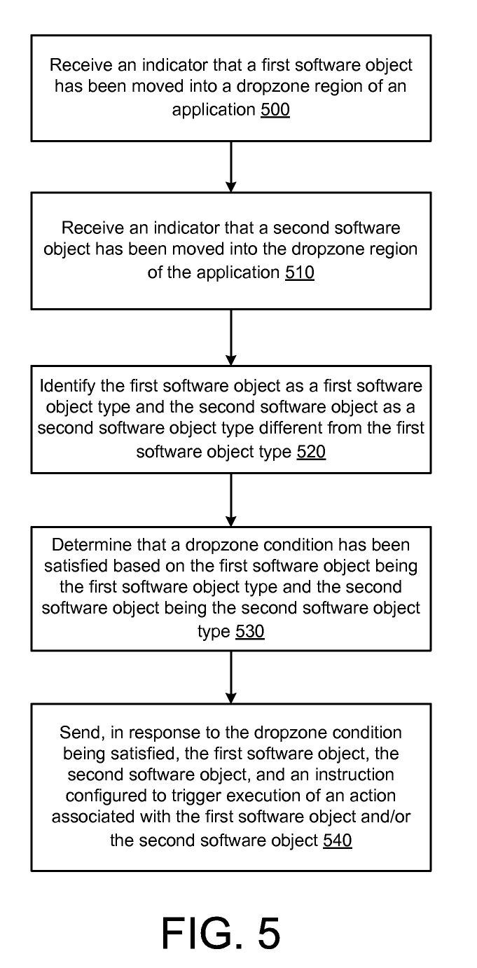

FIG. 5 is a flowchart that illustrates a method for determining whether or not a dropzone condition associated with a dropzone region has been satisifed. As shown in FIG. 5, an indicator that a first software object has been moved into a dropzone region of an application is received (block 500). The first software object can be moved into the dropzone region of the application by a user using, for example, a drag-and-drop function. The indicator associated with the first software object can be received at, for example, a dropzone analyzer.

An indicator that a second software object has been moved into the dropzone region of the application is received (block 510). The second software object can be moved into the dropzone region of the application by a user using, for example, a drag-and-drop function. The indicator associated with the second software object can be received at, for example, a dropzone analyzer.

The first software object can be identified as a first software object type and the second software object as a second software object type different from the first software object type (block 520). The first software type object and/or the second software object type can be, for example, a text file, or an image file.

A dropzone condition can be determined to be satisfied based on the first software object being the first object type and the second software object being the second object type (block 530). The dropzone condition can be determined to be satisfied by, for example, a dropzone analyzer.

In response to the dropzone condition being satisfied, the first software object, the second software object, and an instruction configured to trigger execution of an action associated with the first software object and/or the second software object can be sent (block 540). In some embodiments, the first software object, the second software object, and an instruction configured to trigger execution of an action associated with the first software object and/or the second software object can be sent from a client device on a client side of a network to, for example, an action engine on a server side of the network.

FIG. 6 is another timing diagram that illustrates processing of software objects moved into a dropzone region 60 on a client side of a network 600. As shown in FIG. 6, the dropzone region 60, a dropzone analyzer 620, and a dropzone memory 640 are on the client side of the network 600. A server database 680, an object analyzer 672, and an action engine 674 are disposed on a server side of the network 600.

As shown in FIG. 6, in response to software object A being moved into the dropzone region 60, an indicator that software object A has been moved into the dropzone region 60 is received by the dropzone analyzer 620. The dropzone analyzer 620 is configured to send software object A (e.g., move an instance of software object A) to the dropzone memory 640 (e.g., a dropzone buffer within the dropzone memory 640). In some embodiments, the software object A can be moved from one application into another application (or within a single application) that includes the dropzone region 60 using, for example, a drag-and-drop function.

In response to the software object being moved into the dropzone region 60, the software object A is sent to the dropzone memory 640 so that the software object A can be, for example, buffered for further processing by the dropzone analyzer 620. The software object A is also sent from the dropzone analyzer 620 to the object analyzer 672.

As shown in FIG. 6, the software object A is analyzed by the object analyzer 672. The analysis can include, for example, extracting and/or analyzing content from software object A, storing information about software object A, analyzing metadata related to software object A, determining whether software object A is a particular type of software object, and/or so forth.

In some embodiments, the object analyzer 620 can be configured to analyze software objects such as software object A in various ways using algorithms and/or instructions. For example, the object analyzer 620 can be configured to parse portions of software objects, duplicate or delete portions of software objects, decrypt/encrypt portions of software object, etc. The object analyzer 620 can be configured to perform analysis of text, waveforms (e.g., digital waveforms, analog waveforms), images, video, etc. of software objects.

Also, as shown in FIG. 6, the dropzone analyzer 620 is configured to trigger storage of the software object A (e.g., movement of an instance of software object A) at the server database 680 (e.g., a dropzone buffer within the server database 680). The software object A can be stored in the server database 680 so that, for example, the object analyzer 672 and/or the action engine 674 on the server side of the network 600 may access the software object A for processing. For example, the object analyzer 672 may access the software object A during the analysis process. In some embodiments, the action engine 672 may access the software object A when performing an action related to software object A in the event that a dropzone condition is satisfied (as determined by the dropzone analyzer 620).

After (or during) analysis of the software object A, the object analyzer 672 is configured to send a metadata value associated with software object A to the dropzone analyzer 620. The metadata value can represent, for example, information about the software object A (e.g., content of the software object A, type of software object A). The object analyzer 672 can be configured to define the metadata value so that the dropzone analyzer 620 can determine whether or not movement of the software object A into the dropzone region 60 will satisfy one or more dropzone conditions. For example, the object analyzer 672 can be configured to send a metadata value, such as a content value that represents the type of content included in software object A. The content value can be used by the dropzone analyzer 620 to determine whether or not one or more dropzone conditions is satisfied.

In some embodiments, the dropzone analyzer 620 can be configured to send a set of metadata values (including content values, object type value, other metadata values) about software object A to the dropzone analyzer 620. In such instances, the object analyzer 672 can be configured to perform a predefined analysis of a software object so that a predefined set of metadata values related to software objects, such as software object A, can be defined. The set of metadata values can be sent from the object analyzer 672 to the dropzone analyzer 620.

In some embodiments, the dropzone analyzer 620 can be configured to request that the object analyzer 672 analyze the software object A perform a particular type of analysis. For example, the dropzone analyzer 620 may be configured to request that the object analyzer 672 analyze the software object A for a particular content signature, a particular content type, and/or so forth. In some embodiments, the dropzone analyzer 620 can be configured to send several requests for analysis to (and receive several responses from) the object analyzer 672 any time after receiving the indicator that the software object A has been moved into the dropzone region 60.

As shown in FIG. 6, dropzone conditions are accessed from the dropzone memory 640 by the dropzone analyzer 620 so that the dropzone analyzer 620 can determine whether or not one or more of the dropzone conditions stored in the dropzone memory 640 are satisfied. In this embodiment, the dropzone analyzer 620 is configured to determine whether or not one or more of the dropzone conditions stored in the dropzone memory 640 are satisfied based on the metadata value returned from the object analyzer 672.

As shown in FIG. 6, in response to receipt of the metadata value, the dropzone analyzer 620 is configured to determine that a dropzone condition has not been satisfied (or cannot be satisfied) based on the metadata value. For example, the dropzone analyzer 620 may determine that the dropzone condition associated with the metadata value associated with software object A does not exist. In response to this determination, the dropzone analyzer 620 is configured to remove the software object A from the dropzone memory 640 and trigger the server database 680 to remove the software object A from the server database 680.

Although not shown, in some embodiments, in response to determining that a dropzone condition is not satisfied (or cannot be satisfied) based on the metadata value, the dropzone analyzer 620 can be configured to request that the object analyzer 672 further analyze the software object A (e.g., perform a particular type of analysis). The dropzone analyzer 620 can be configured to request that the object analyzer 672 further analyze the software object A before the software object A is removed from the dropzone memory 640 and the server database 680.

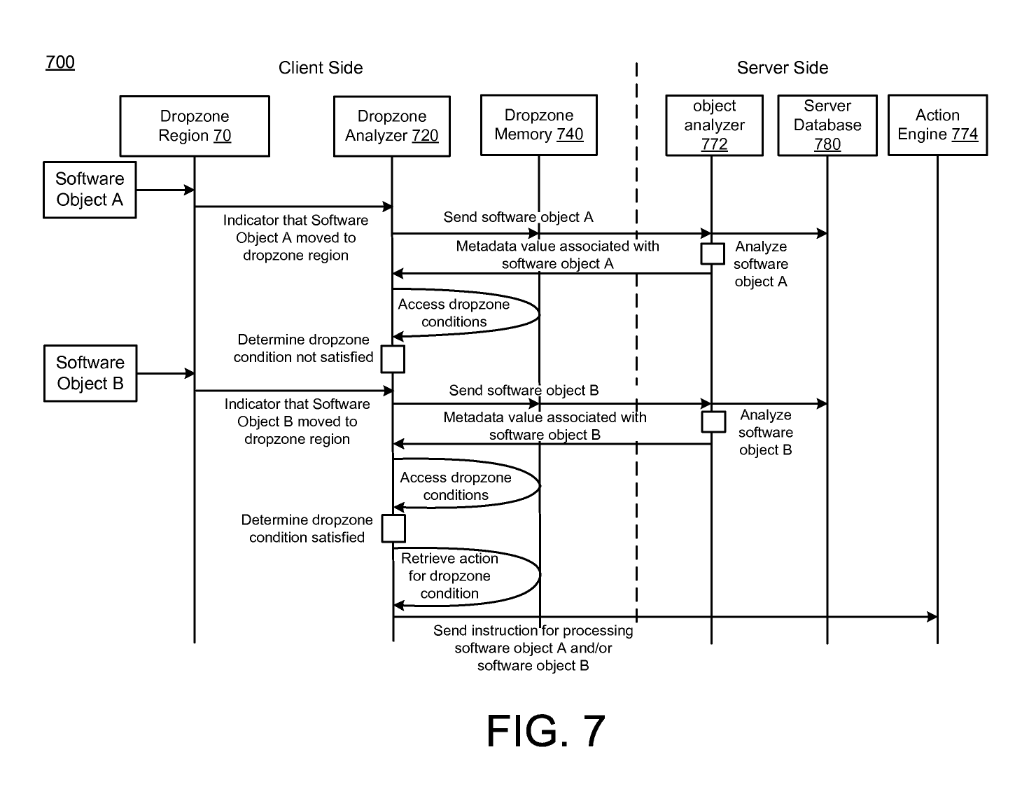

FIG. 7 is yet another timing diagram that illustrates processing of software objects moved into a dropzone region 70 on a client side of a network 700. As shown in FIG. 7, the dropzone region 70, a dropzone analyzer 720, and a dropzone memory 740 are disposed on the client side of the network 700. A server database 780, an object analyzer 772, and an action engine 774 are disposed on a server side of the network 700.

As shown in FIG. 7, in response to software object A being moved into the dropzone region 70, an indicator that software object A has been moved into the dropzone region 70 is received by the dropzone analyzer 720. In response to the software object being moved into the dropzone region 70, the software object A is sent to the dropzone memory 740 so that software object A can be, for example, buffered for further processing by the dropzone analyzer 720. The software object A is also sent from the dropzone analyzer 720 to the object analyzer 772, and the dropzone analyzer 720 is configured to trigger storage of the software object A at the server database 780.

As shown in FIG. 7, the software object A is analyzed by the object analyzer 772, and the object analyzer 772 is configured to send a metadata value associated with software object A to the dropzone analyzer 720. In response to receipt of the metadata value, dropzone conditions are accessed from the dropzone memory 740 by the dropzone analyzer 720 so that the dropzone analyzer 720 can determine whether or not one or more of the dropzone conditions stored in the dropzone memory 740 are satisfied. In this embodiment, the dropzone analyzer 720 is configured to determine whether or not one or more of the dropzone conditions stored in the dropzone memory 740 are satisfied based on the metadata value returned from the object analyzer 772.

As shown in FIG. 7, the dropzone analyzer 720 is configured to determine that a dropzone condition has not been satisfied based on the metadata value. In this embodiment, the dropzone analyzer 720 is configured to determine that at least one of the dropzone conditions could be satisfied based on a second software object being moved into the dropzone region 70. Accordingly, the dropzone analyzer 720 can be configured to wait for another object that satisfies the dropzone condition(s) to be moved into the dropzone region 70, and the dropzone analyzer 720 can be configured so that the dropzone analyzer 720 does not trigger removal of the software object A from the dropzone memory 740 or the server database 780. In such embodiments, the dropzone analyzer 720 can be configured to identify a subset of dropzone conditions that could be satisfied based on a second software object being moved into the dropzone region 70.

As shown in FIG. 7, in response to software object B being moved into the dropzone region 70, an indicator that software object B has been moved into the dropzone region 70 is received by the dropzone analyzer 720. In response to the software object being moved into the dropzone region 70, the software object B is sent to the dropzone memory 740 so that the software object B can be, for example, buffered for further processing by the dropzone analyzer 720. The software object B is also sent from the dropzone analyzer 720 to the object analyzer 772, and the dropzone analyzer 720 is configured to trigger storage of software object B at the server database 780.

As shown in FIG. 7, the software object B is analyzed by the object analyzer 772, and the object analyzer 772 is configured to send a metadata value associated with software object B to the dropzone analyzer 720. In response to receipt of the metadata value associated with software object B, dropzone conditions are accessed from the dropzone memory 740 by the dropzone analyzer 720 so that the dropzone analyzer 720 can determine whether or not one or more of the dropzone conditions stored in the dropzone memory 740 are satisfied. Although not shown, in some embodiments, analysis of software object A and/or B could be performed on the client side of the network 700.

In some embodiments, only the subset of dropzone conditions that could be satisfied based on a second software object being moved into the dropzone region 70 may be analyzed by the dropzone analyzer 720 in response to receipt of the metadata value associated with software object B. Although not shown, if a dropzone condition were not satisfied based a combination of software object A and B, the dropzone analyzer 720 can be configured to wait for an additional software object to be moved into the dropzone region 70 to determine whether or not one or more of the dropzone conditions may be satisfied based on a combination of the additional software object and software object A and/or B. In some embodiments, the scope of the dropzone conditions (e.g., the subset of dropzone conditions) that could be satisfied based on software object A, software object B, or the additional software object can be determined and can be different.

As shown in FIG. 7, the dropzone analyzer 720 is configured to determine that a dropzone condition has been satisfied. In some embodiments, multiple dropzone conditions may be satisfied in response to software objects A and B being moved into the dropzone region 70. In such instances, priority values, such as condition priority values, object priority values, region priority values, and/or so forth can be used to determine how processing of dropzone conditions should be handled, processing of software object A and/or B (based on an action) should be handled in the event that a dropzone condition is satisfied, and/or so forth.

As shown in FIG. 7, the dropzone analyzer 720 is configured to send, to the action engine 774 on the server side of the network, an instruction (which may function as, or in lieu of, an indicator) for processing of software object A and/or B. The instruction is sent in response to the dropzone condition being satisfied. In some embodiments, the instruction can specify a particular action to be performed by the action engine 774 in response to the dropzone condition being satisfied. In such embodiments, the instruction can be referred to as an action instruction. The instruction can be defined based on a determination (e.g., a look-up in a dropzone database) by the dropzone analyzer of an action to be performed based on the particular dropzone condition being satisfied. Accordingly, the action engine 774 may not need to determine (e.g., locate, look-up) an action to be performed based on the particular dropzone condition being satisfied.

Also, because both software object A and software object B are already stored at the server database 780, the dropzone memory 740 does not need to send software object A (e.g., an instance of software object A) and/or software object B (e.g., an instance of software object B) to the server side of the network 700 in response to the dropzone condition being satisfied. Accordingly, the action engine 774 can be configured to access software object A and/or B from the server database 780 to perform an action with respect to software object A and/or B.

Although not shown, in some embodiments, an action related to software object A and/or B can be performed on the client side of the network 700, at, for example, a client device. In such embodiments, an action may not performed on the server side of the network (e.g., by the action engine 774), and an instruction may not be sent to the server side of the network.

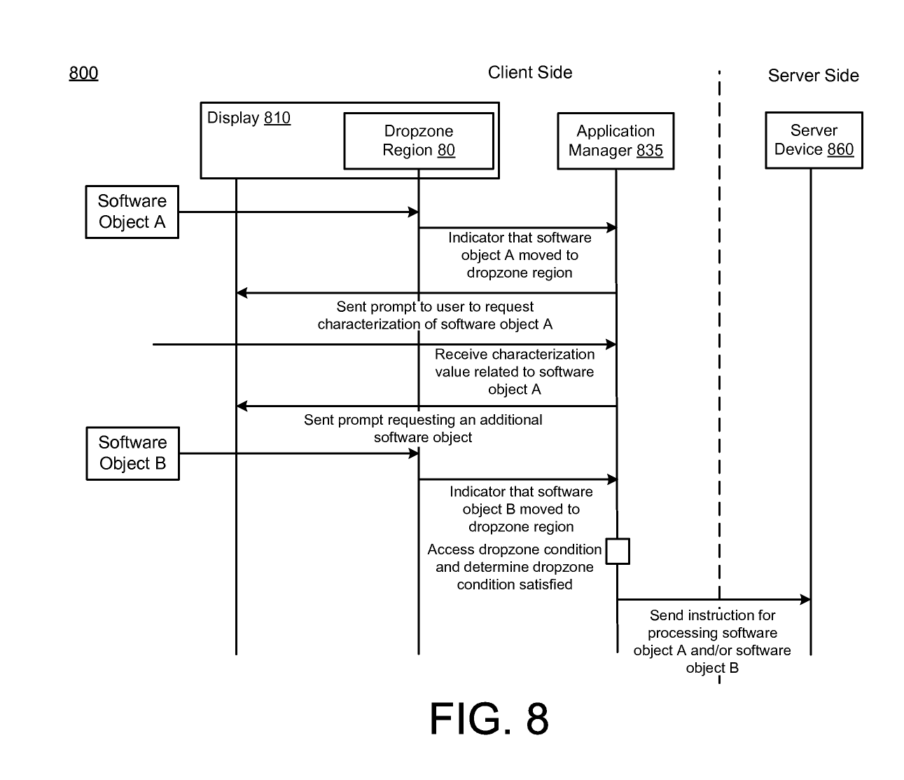

FIG. 8 is timing diagram that illustrates processing of software objects moved into a dropzone region 80 on a client side of a network 800 based on prompts. As shown in FIG. 8, a dropzone region 80, a display 810, and an application manager 835 are disposed on the client side of the network 800. A server device 860 is disposed on a server side of the network 800.

As shown in FIG. 8, in response to software object A being moved into the dropzone region 80, an indicator that software object A has been moved into the dropzone region 80 is received by the application manager 835. In some embodiments, the software object A can be moved from one application into another application (or within a single application) that includes the dropzone region 80 using, for example, any type of file transfer function.

In response to software object A being moved into the dropzone region 80, a prompt is sent to a user to request characterization of the software object A. Specifically, the prompt is triggered for display by the application manager 835 (e.g., a client device communicator of the application manager 835) at the display 810. Specifically, the application manager 835 can be configured to prompt a user to communicate (e.g., enter) information related to software object A, which has been moved into the dropzone region 80. For example, the application manager 835 can be configured to prompt a user to identify a particular software object, enter information about the type and/or content of a software object, and/or so forth.

In response to the prompt, the user can enter information related to software object A and the information can be received as an input metadata value related to software object A. The input metadata value can be, or can include, for example, any of information related to the metadata values, but is referred to as an input metadata value because it is a value entered by a user.

As shown in FIG. 8, the application manager 835 is configured to prompt a user (via the display 810) to request an additional software object. The prompt can be a request for the user to move the additional software object into the dropzone region 80. In some embodiments, the request for the additional software object can be a request for an additional software object with a particular characteristic (e.g., of a particular type, with a particular content, etc.). In some embodiments, the request can be defined based on analysis by the application manager 835 of a subset of dropzone conditions that may be satisfied in response to software object A being moved into the dropzone region A. In some embodiments, the request for the additional software object can be based on analysis by the application manager 835 of the input metadata value related to software object A. For example, the application manager 835 can be configured to determine that software object A is a particular type of software object based on the input metadata value. The application manager 835 can then be configured to determine that a subset of dropzone conditions may be satisfied based on a combination of software object A and another software object that is a specific type of software object. Accordingly, the application manager 835 can send a request for the software object that is the specific type of software object.

As shown in FIG. 8, software object B is moved into the dropzone region after the request for the additional software object is sent (as a prompt). In response to software object B being moved into the dropzone region 80, an indicator that software object B has been moved into the dropzone region 80 is sent to and received by the application manager 835.

As shown in FIG. 8, the dropzone analyzer 820 is configured to access dropzone conditions and determine that a dropzone condition (from the dropzone conditions) has been satisfied. The determination that the dropzone condition has been satisfied can be made based on analysis of software object B and/or the input metadata value related to software object A. In some embodiments, the determination that the dropzone condition has been satisfied can be based merely on fact that an additional software object (i.e., software object B) has been moved into the dropzone region 80.

As shown in FIG. 8, the dropzone analyzer 820 is configured to send, to the server device 860 on the server side of the network, an instruction (which may function as, or in lieu of, an indicator) for processing of software object A and/or B. The instruction is sent in response to the dropzone condition being satisfied. In some embodiments, the instruction can specify a particular action to be performed by the server device 860 in response to the dropzone condition being satisfied.

Implementations of the various techniques described herein may be implemented in digital electronic circuitry, or in computer hardware, firmware, software, or in combinations of them. Implementations may implemented as a computer program product, i.e., a computer program tangibly embodied in an information carrier, e.g., in a machine-readable storage device or in a propagated signal, for execution by, or to control the operation of, data processing apparatus, e.g., a programmable processor, a computer, or multiple computers. A computer program, such as the computer program(s) described above, can be written in any form of programming language, including compiled or interpreted languages, and can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in special purpose logic circuitry.

To provide for interaction with a user, implementations may be implemented on a computer having a display device, e.g., a cathode ray tube (CRT) or liquid crystal display (LCD) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations may be implemented in a computing system that includes a back-end component, e.g., as a data server, or that includes a middleware component, e.g., an application server, or that includes a front-end component, e.g., a client computer having a graphical user interface or a Web browser through which a user can interact with an implementation, or any combination of such back-end, middleware, or front-end components. Components may be interconnected by any form or medium of digital data communication, e.g., a communication network. Examples of communication networks include a LAN and a WAN, e.g., the Internet.

While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the embodiments.

What is claimed is:

1. A non-transitory computer-readable storage medium storing code representing instructions that when executed are configured to cause a processor to perform a process, the code comprising code to:
receive, on a client side of a network, an indicator that a first software object has been moved from a first application into a dropzone region of a second application;
receive an indicator that a second software object has been moved into the dropzone region of the second application;
access a plurality of dropzone conditions;
determine that a dropzone condition from the plurality of dropzone conditions has been satisfied based on the first software object and the second software object both being moved into the dropzone region; and
send to a server side of a network an indicator that the dropzone condition has been satisfied.

2. The non-transitory computer-readable storage medium of claim 1, the code further comprising code to:
store the first software object in an object buffer associated with the second application in response to the first software object being moved into the dropzone region of the second application, the object buffer being on the client side of the network;
store the second software object in the object buffer in response to the second software object being moved into the dropzone region of the second application; and
send the first software object and the second software object from the object buffer to a server device on the server side of the network in response to the dropzone condition being satisfied.

3. The non-transitory computer-readable storage medium of claim 1, wherein the dropzone region is a first dropzone region, the dropzone condition is a first dropzone condition from the plurality of dropzone conditions,
the code further comprising code to:
receive an indicator that a third software object has been moved into a second dropzone region of the second application, the second dropzone region being mutually exclusive from the first dropzone region of the second application;
determine that a second dropzone condition from the plurality of dropzone conditions has been satisfied based on the third software object and the first software object both being moved into the dropzone region.

4. The non-transitory computer-readable storage medium of claim 1, wherein the dropzone condition is a first dropzone condition from the plurality of dropzone conditions,
the code further comprising code to:
receive an indicator that a third software object has been moved into the dropzone region;
determine that a second dropzone condition from the plurality of dropzone conditions has been satisfied based on the third software object and the first software object both being moved into the dropzone region; and
prevent sending to the server side of the network an indicator that the second dropzone condition has been satisfied, the sending being prevented until an indicator that an action associated with the first dropzone condition has been performed on the server side of the network is received, the sending being prevented when the first dropzone condition has a priority that is higher than a priority of the second dropzone condition.

5. The non-transitory computer-readable storage medium of claim 1, the code further comprising code to:
receive an indicator that a third software object has been moved into the dropzone region; and
determine that the dropzone condition from the plurality of dropzone conditions has not been satisfied based on the third software object and the first software object both being moved into the dropzone region.

6. The non-transitory computer-readable storage medium of claim 1, the code further comprising code to:
receive an indicator that a third software object has been moved into the dropzone region;
store the third software object in an object buffer associated with the second application in response to the third software object being moved into the dropzone region of the second application;
analyze at least a portion of content of the third software object or an input metadata value associated with the third software object;
determine, based on the analysis, that the third software object is not associated with at least one dropzone condition from the plurality of dropzone conditions; and
remove the third software object from the object buffer in response to the determining that the third software object is not associated with the at least one dropzone condition from the plurality of dropzone conditions.

7. The non-transitory computer-readable storage medium of claim 1, wherein the dropzone condition from the plurality of dropzone conditions is satisfied when the second software object is moved into the dropzone region within a specified time period after the first software object has been moved into the dropzone region.

8. The non-transitory computer-readable storage medium of claim 1, wherein the first software object is moved into the dropzone region before the second software object is moved into the dropzone region, the dropzone condition is satisfied in response to the first software object being moved into the dropzone region before the second software object is moved into the dropzone region,
the code further comprising code to:
determine that the dropzone condition is not satisfied when the second software object is moved into the dropzone region before the first software object is moved into the dropzone region.

9. The non-transitory computer-readable storage medium of claim 1, wherein the first software object is a first object type, the second software object is a second object type different from the first object type,
the dropzone condition is satisfied in response to the first software object being the first object type and the second software object being the second object type.

10. The non-transitory computer-readable storage medium of claim 1, wherein the first application is executing within an operating system environment of a client device on the client side of a network as an application that is independent from the second application, which is also executing within the operating system environment of the client device.

11. The non-transitory computer-readable storage medium of claim 1, further comprising code to:
trigger display, at a display of a client device, a prompt requesting information characterizing at least one of the first software object or the second software object;
receive, via the client device, at least one input metadata value in response to the prompt; and
determine that the dropzone condition from the plurality of dropzone conditions is satisfied based on the at least one input metadata value.

12. The non-transitory computer-readable storage medium of claim 1, further comprising code to:
send a request for a content analysis of the first software object and the second software object to a server side of the network; and
receive, from the server side of the network and in response to the request, a content value of the first software object and a content value of the second software object,
the dropzone condition being satisfied in response to the content value of the first software object and the content value of the second software object.

13. The non-transitory computer-readable storage medium of claim 1, wherein the indicator is associated with an instruction configured to trigger a server device on a server side of a network to process at least one of the first software object or the second software object.

14. A computer system including instructions stored on a non-transitory computer-readable storage medium, the computer system comprising:
an object analyzer on a server side of a network configured to receive a first software object and a second software object from a client device on a client side of the network, the object analyzer configured to analyze the first software object and the second software object, the object analyzer configured to send a content value representing at least a portion of content of the first software object to the client device; and
an action engine configured to receive, from the client device and after the content value is sent by the object analyzer, an instruction to execute an action related to at least one of the first software object or the second software object, the instruction being defined in response to a dropzone condition being satisfied when the first software object and the second software object are moved into a dropzone region at the client device.

15. The computer system of claim 14, wherein the object analyzer is configured to identify at least a portion of content of the second software object in response to the instruction,
the computer system further comprising:
a database engine configured to query at least a portion of a server database based on the portion of content of the second software object and based on the instruction.

16. The computer system of claim 14, further comprising:
a dropzone updater configured to receive an update to the dropzone condition, the dropzone updater configured to send the update of the dropzone condition from the server side of the network to the client device on the client side of the network.

17. The computer system of claim 14, wherein the object analyzer is configured to receive a third software object from the client device on the client side of the network, the dropzone condition is a first dropzone condition,
the object analyzer is configured to determine at least a portion of content of the third software object,
the computer system further comprising:
a dropzone updater configured to send a second dropzone condition from the server side of the network to the client device on the client side of the network based on the at least the portion of the content of the third software object.

18. A method including executing instructions recorded on a non-transitory computer-readable storage media using at least one processor, the method comprising:
receiving, using the at least one processor, an indicator that a first software object has been moved into a dropzone region of an application;
receiving, using the at least one processor, an indicator that a second software object has been moved into the dropzone region of the application;
identifying the first software object as a first object type and the second software object as a second object type different from the first object type;
determining that a dropzone condition has been satisfied based on the first software object being the first object type and the second software object being the second object type; and
sending, in response to the dropzone condition being satisfied, the first software object, the second software object, and an instruction configured to trigger execution of an action associated with at least one of the first software object or the second software object.

19. The method of claim 18, wherein:
the first object type is a first file type and the second object type is a second file type; and
the action is a predefined action selected from a plurality of actions based the dropzone condition and the functionality of the application.

20. The method of claim 18, further comprising:
receiving, using the at least one processor, an indicator that a third software object has been moved into the dropzone region of the application;
storing the third software object in an object buffer; and
removing the third software object from the object buffer in response to the dropzone condition being satisfied based on the first object type of the first software object and the second object type of the second software object.
